(19) United States
(12) Patent Application Publication
(10) Pub. No.: US 2026/0353155 A1
(43) Pub. Date: Nov. 5, 2026

(54) APPARATUS, METHOD AND READABLE STORAGE MEDIUM FOR COMMUNICATING A SENSING QUALITY OF SERVICE

(71) Applicant: Huawei Technologies Co., Ltd., Shenzhen (CN)

(72) Inventors: Wen Tong, Ottawa (CA); Lei Dong, Shanghai (CN); Hao Tang, Ottawa (CA); Jianglei Ma, Ottawa (CA)

(21) Appl. No.: 19/714,033

(22) Filed: Jun. 19, 2026

Related U.S. Application Data
(63) Continuation of application No. PCT/CN2024/091251, filed on May 6, 2024.

(30) Foreign Application Priority Data
Dec. 22, 2023 (WO) PCT/CN2023/141180

(51) Int. Cl. H04W 24/10; H04L 5/00; H04L 27/26

(52) U.S. Cl. CPC H04W 24/10; H04L 5/0048; H04L 27/2603

(57) ABSTRACT

Embodiments of the present application provide a communication method and communication apparatus. In the method, a first network element may transmit a sensing request and information indicating sensing QoS for sensing the sensing data to one or more second network elements. The one or more second network elements may collect the sensing data based on the received sensing QoS and transmit the sensing data to the first network element.

### CROSS-REFERENCE TO RELATED APPLICATIONS

This application is a continuation of Patent Cooperation Treaty International Patent Application No. PCT/CN2024/091251, filed on May 6, 2024, which claims priority to Patent Cooperation Treaty International Patent Application No. PCT/CN2023/141180 filed on Dec. 22, 2023, entitled “Apparatus, Method and Readable Storage Medium for Communication.” The entire contents of the aforementioned applications are incorporated herein by reference.

### TECHNICAL FIELD

Embodiments of the present application relate to the field of communications, and more specifically, to apparatus, method and readable storage medium for communication involving data sensing.

### BACKGROUND

With the evolution of communication system, integrated sensing and communication (also known as integrated communication and sensing, joint sensing and communication, and other similar names) or integrated sensing and artificial intelligence/machine learning (AI/ML) is a desirable feature in existing and future communication systems. But the framework or signaling implement procedure for those communication systems have not been issued.

### SUMMARY

Embodiments of the present application provide apparatus, method and readable storage medium for communication involving data sensing.

A first aspect of the disclosure involves a communication method at a first network element, comprising: transmitting a sensing request and a first information, wherein the sensing request is used for requesting one or more second network elements to collect sensing data, and the first information indicates a sensing quality of service (QoS) for collecting the sensing data; and receiving the sensing data.

In method in the first aspect, the first network element (e.g. user equipment or base station) may transmit sensing QoS (the first information) for sensing data to the second network elements (e.g. user equipment(s) or base station(s)), so that the second network elements can collect sensing data according to the sensing QoS and transmit collected sensing data to the first network element. Hence the first network element can perform/realize corresponding service(s) (e.g. local service or 3rd service) with the sensing data, which can ensure the sensing data to be collected with the demand of the service(s).

In some embodiments of the first aspect, the first network element may be a UE or a BS.

One or more embodiments according to the method in the first aspect, the sensing QoS comprises one or more performance metrics, and the one or more performance metrics comprises at least one of the following performance metrics: positioning accuracy, speed accuracy, angle accuracy, positioning resolution, speed resolution, angle resolution, sensing range, latency, identification probability, false alarm probability, or missed detection probability.

One or more embodiments according to the method in the first aspect, the first information comprises a first parameter indicating a set of values corresponding to the one or more performance metrics; or the first information comprises a set of values corresponding to the one or more performance metrics.

In those embodiments, the first parameter may be QoS level in the description part. It may reduce communication resource exhausting while transmitting the first parameter.

One or more embodiments according to the method in the first aspect, the sensing request and the first information are transmitted on a scheduling request (SR) resource; or the sensing request and the first information are transmitted on physical uplink control channel (PUCCH) resources other than the SR resource; or the sensing request is transmitted on the SR resource and the first information is transmitted on PUCCH resources other than the SR resource.

In those embodiments, the sensing request and the first information and the first request may be transmitted in the same ways (e.g. SR resource, PUCCH resources other than SR resource), or in different ways (e.g. one is transmitted on SR resource and the other one is transmitted on PUCCH resources other than SR resource).

One or more embodiments according to the method in the first aspect, wherein the first network element is a first base station (BS), the one or more second network elements comprise a second UE, and the transmitting the sensing request and the first information comprises: transmitting the sensing request and the first information to the second UE via a physical downlink control channel.

One or more embodiments according to the method in the first aspect, wherein the first network element is a first user equipment (UE) served by a second BS, the one or more second network elements comprise a third BS, and the transmitting the sensing request and the first information comprises: transmitting the sensing request and the first information to the third BS via a core network.

One or more embodiments according to the method in the first aspect, wherein the receiving the sensing data comprises: receiving the sensing data from the second BS, wherein the sensing data is transmitted to the second BS via the third BS and the core network.

One or more embodiments according to the method in the first aspect, wherein the sensing data is an input or a training data of a first model deployed at the first network element, and wherein: the first model is a compressed model of a second model deployed at a BS serving the first network element in a case where the first network element is a UE, or the first model is a distilled model of a third model deployed at a core network in a case where the first network element is a BS.

A second aspect of the disclosure involves a communication method at a second network element, comprising: receiving a sensing request and a first information, wherein the first information indicates a sensing quality of service (QoS) for collecting sensing data corresponding to the sensing request; and transmitting the sensing data, wherein the sensing data is collected based on the sensing QoS.

In method in the second aspect, the second network elements may collect sensing data according to the sensing QoS receiving from the first network element and transmit collected sensing data to the first network element. Hence the first network element can perform/realize corresponding service(s) (e.g. local service or 3rd service) with the sensing data, which can ensure the sensing data to be collected with the demand of the service(s).

In some embodiments of the second aspect, the sensing data is collected by the second network element and/one or more UEs served by the second network element. For example, the second network element may transmit the sensing request and the first information to one or more UEs served by the second network element to instruct the one or more UEs to collect the sensing data. And the second network element may transmit the sensing data received from the one or more UEs (together with sensing data collected by itself) to the first network element.

One or more embodiments according to the method in the second aspect, the sensing QoS comprising one or more performance metrics, and the one or more performance metrics comprises at least one of the following performance metrics: positioning accuracy, speed accuracy, angle accuracy, positioning resolution, speed resolution, angle resolution, sensing range, latency, identification probability, false alarm probability, or missed detection probability.

One or more embodiments according to the method in the second aspect, the first information comprises a first parameter indicating a set of values corresponding to the one or more performance metrics; or the first information comprises a set of values corresponding to the one or more performance metrics.

In those embodiments, the first parameter may be QoS level in the description part. It may reduce communication resource exhausting while transmitting the first parameter.

One or more embodiments according to the method in the second aspect, wherein the sensing data is collected by transmitting one or more signals, and the one or more signals is transmitted under a set of air interface parameters corresponding to the sensing QoS.

One or more embodiments according to the method in the second aspect, wherein the set of air interface parameters comprises one or more of the following parameters: allowed subcarrier spacing, sensing periodicity, sensing window length, bandwidth for sensing, carrier frequency, sensing waveform, sensing power, antenna elements, reporting data format, or reporting resource.

One or more embodiments according to the method in the second aspect, wherein the set of air interface parameters is selected from a plurality of sets of air interface parameters based on the first information.

One or more embodiments according to the method in the second aspect, wherein the second network element is a BS, and the method further comprises transmitting the set of air interface parameters to one or more UEs served by the second network element.

In those embodiments, the one or more UEs may configure their air interfaces according to the set of air interface parameters and collet sensing data with configured air interface.

In those embodiments, the second network element may the set of air interface parameters to the one or more UEs, hence the one or more UEs may collet sensing data according to the set of air interface parameters.

One or more embodiments according to the method in the second aspect, wherein the second network element is a base station, and: the sensing request and the first information are transmitted on a scheduling request (SR) resource, or the sensing request and the first information are transmitted on physical uplink control channel (PUCCH) resources other than the SR resource, or the sensing request is transmitted on the SR resource and the first information is transmitted on PUCCH resources other than SR resource, or the sensing request and the first information are transmitted by a core network.

One or more embodiments according to the method in the second aspect, wherein collecting the sensing data based on the sensing QoS comprises: collecting the sensing data based on a set of air interface parameters corresponding to the sensing QoS.

A third aspect of the disclosure involves a communication method at a core network element, comprising: receiving a sensing request and a first information, wherein the sensing request is used to request one or more second network elements to collect sensing data, and the first information indicates a sensing quality of service (QoS) for collecting the sensing data; transmitting a trigger request to trigger the one or more second network elements to collect the sensing data based on the sensing QoS; receiving the sensing data from the one or more second network elements; and transmitting the sensing data.

One or more embodiments according to the method in the third aspect, wherein the method further comprises: transmitting a second information indicating a legacy QoS identifier corresponding to the sensing QoS.

A fourth aspect of the disclosure involves a communication method at a communication system, the communication system comprising a first network element and one or more second network elements; and the method comprising: the first network element transmitting a sensing request and a first information to the one or more second network elements, wherein the first information indicates a sensing quality of service (QoS) for collecting sensing data corresponding to the sensing request; and the one or more second network elements transmitting the sensing data to the first network element, wherein the sensing data is collected based on the sensing QoS.

A fifth aspect of the disclosure involves an apparatus, wherein the apparatus comprises a processor, wherein the processor is configured to execute one or more instructions stored in a memory, to enable the apparatus to implement any method involved in the first aspect to the fourth aspect.

One or more embodiments of the apparatus in the fifth aspect, wherein the apparatus comprises the memory.

One or more embodiments of the apparatus in the fifth aspect, wherein the apparatus comprises a communication interface, configured to input and/or output information.

A sixth aspect of the disclosure involves an apparatus, wherein the apparatus comprises a function or unit to implement any method involved in the first aspect to the fourth aspect.

In some embodiments, the apparatus of the third or sixth aspect of the disclosure is a terminal, a base station, a communication module in the terminal or the base station, chip or chipset in the terminal or the base station.

A seventh aspect of the disclosure involves an apparatus comprising means to perform the method according to any method involved in the first aspect to the fourth aspect.

An eighth aspect of the disclosure involves a computer readable storage medium, comprising one or more instructions, wherein when the instructions are run on a computer, the computer performs any method involved in the first aspect to the fourth aspect.

A ninth aspect of the disclosure involves a computer program product comprising a non-transitory computer-readable medium storing computer executable instructions to perform any method involved in the first aspect to the fourth aspect.

The detail explanation and beneficial effects of the fourth aspect to the ninth aspect may refer to the first aspect to the third aspect.

### DESCRIPTION OF THE DRAWINGS

FIG. 1 illustrates an examples of wireless communication system according to some embodiments of the disclosure.

FIG. 2 illustrates more detailed example for communication system 100 according to some embodiments of the disclosure.

FIG. 3 illustrates example of an Apparatus 310 according to some embodiments of the disclosure.

FIG. 4 illustrates units or modules in a device or apparatus according to some embodiments of the disclosure.

FIG. 5 illustrates an AI framework in 5G by RAN3 according to some embodiments of the disclosure.

FIG. 6 illustrates an AI framework in 5G by RAN1 according to some embodiments of the disclosure.

FIG. 7 illustrates an intelligent RAN framework according to some embodiments of the disclosure.

FIG. 8 illustrates a knowledge distillation process according to some embodiments of the disclosure.

FIG. 9 illustrates a knowledge distillation process according to some embodiments of the disclosure.

FIG. 10 illustrates an example of sensing request and QoS configuration according to some embodiments of the disclosure.

FIG. 11 illustrates a scene in which sensing request is associated with SR resource according to some embodiments of the disclosure.

FIG. 12 illustrates a scene in which sensing request is associated with sensing request resource according to some embodiments of the disclosure.

FIG. 13 illustrates a scene in which sensing request is identify by different sequence according to some embodiments of the disclosure.

FIG. 14A illustrates an illustrative relationship between network elements according to some embodiments of the disclosure.

FIG. 14B illustrates a flowchart of a communication method according to some embodiments of the disclosure.

FIG. 15 illustrates a scene in which Sensing QoS level grouping according to some embodiments of the disclosure.

FIG. 16 illustrates a flow diagram of a communication method according to some embodiments of the disclosure.

FIG. 17 illustrates a schematic block diagram of an apparatus according to some embodiments of this disclosure.

### DETAILED DESCRIPTION OF THE ILLUSTRATIVE EMBODIMENTS

The following describes technical solutions of the present application with reference to the accompanying drawings.

For ease of understanding the embodiments of this application, communication systems are described below.

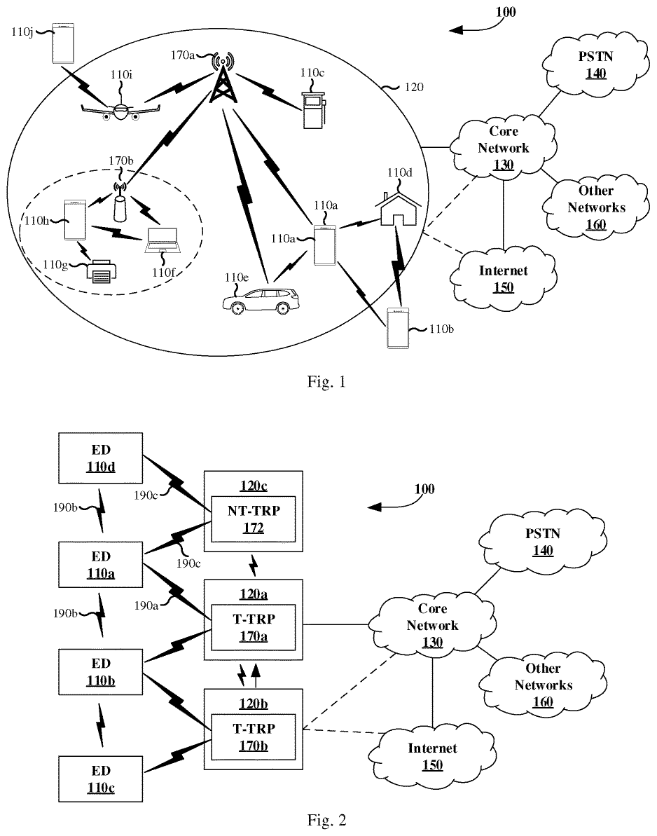

Referring to FIG. 1, as an illustrative example without limitation, a simplified schematic illustration of a communication system is provided. The communication system 100 (which may be a wireless system) comprises a radio access network 120. The radio access network (RAN) 120 may be a next generation (e.g. sixth generation (6G) or later) radio access network, or a legacy (e.g. 5G, 4G, 3G or 2nd generation (2G)) radio access network. One or more communication electronic device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. The communication system 100 may also comprise a public switched telephone network (PSTN) 140, the internet 150, and other networks 160.

In general, the communication system 100 enables multiple wireless or wired elements to communicate data and other content. The communication system 100 may provide content, such as voice, data, video, and/or text, via broadcast, multicast, groupcast, unicast, etc. And the communication system 100 may provide a wide range of communication services and applications (such as earth monitoring, remote sensing, passive sensing and positioning, navigation and tracking, autonomous delivery and mobility, etc.) The services and/or applications may be mobile broadband (MBB) services, ultra-reliable low-latency communication (URLLC) services, or machine type communication (MTC) services.

The communication system 100 may operate by sharing resources, such as carrier spectrum bandwidth, between its constituent elements.

The communication system 100 may include a terrestrial communication system and/or a non-terrestrial communication system. The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. The heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system.

Same as in the example shown in FIG. 1, in the example shown in FIG. 2, the communication system 100 may include ED 110a, 110b, 110c, 110d (generically referred to as ED 110), and RAN 120a, 120b. In addition, the communication system 100 may also include a non-terrestrial communication network 120c. The communication system 100 may also include one or more of a core network 130, a public switched telephone network (PSTN) 140, the Internet 150, and other networks 160. The RANs 120a, 120b include respective RAN nodes such as base stations (BSs) 170a, 170b, which may be generically referred to as terrestrial transmit and receive points (T-TRPs) 170a, 170b. In one implementation, the non-terrestrial communication network 120c includes a RAN node such as an access node (or base station) 172, which may be generically referred to as a non-terrestrial transmit and receive point (NT-TRP) 172. As may be surmised on the basis of similarity in reference numerals, the non-terrestrial communication network 120c may be considered to be a radio access network, with operational aspects in common with the RANs 120a, 120b. In another implementations, the non-terrestrial communication network 120c may include at least one non-terrestrial network (NTN) device and at least one corresponding terrestrial network device, wherein the at least one non-terrestrial network device works as a transport layer device and the at least one corresponding terrestrial network device works as a RAN node, which communicates with the ED via the non-terrestrial network device. In addition, there may be a NTN gateway in the ground (i.e., referred as a terrestrial network device) also as a transport layer device to communication with both the NTN device, and the RAN node communicates with the ED via the NTN device and the NTN gateway. In some implementations, the NTN gateway and the RAN node may be located in the same device.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, ED 110a may communicate an uplink (UL) and/or downlink (DL) transmission over a terrestrial air interface 190a with T-TRP 170a. In some examples, the EDs 110a, 110b, 10c, and nod may also communicate directly with one another via one or more sidelink (SL) air interfaces 190b. In some examples, ED nod may communicate an uplink and/or downlink transmission over a non-terrestrial air interface 190c with NT-TRP 172.

An air interface (e.g., 190a, 190b, 190c) generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g., data) over a wireless communications link. The wireless communications link may support a link (e.g., a “Uu” link) between a radio access network (e.g., RAN 120) and user equipment (e.g., ED no) and/or the wireless communications link may support a link (e.g., a “LS”) between device (e.g., ED 110a) and device (e.g., ED 110b), such as between two user equipments, and/or the wireless communications link may support a link between a non-terrestrial (NT)-communication network (e.g., RAN 120c) and user equipment (e.g., ED 110d). The following are some examples for the above components.

A waveform component may specify a shape and form of a signal being transmitted. Waveform options may include orthogonal multiple access waveforms and non-orthogonal multiple access waveforms. Non-limiting examples of such waveform options include orthogonal frequency division multiplexing (OFDM), discrete Fourier transform spread OFDM (DFT-OFDM), filtered OFDM (f-OFDM), time windowing OFDM, filter bank multicarrier (FBMC), universal filtered multicarrier (UFMC), generalized frequency division multiplexing (GFDM), wavelet packet modulation (WPM), faster than Nyquist (FTN) waveform and low peak to average power ratio waveform (low peak-to-average power ratio (PAPR) WF).

A frame structure component may specify a configuration of a frame or group of frames. The frame structure component may indicate one or more of a time, frequency, pilot signature, code, subcarrier spacing, cyclic prefix length or other parameter of the frame or group of frames. More details of frame structure will be discussed hereinafter.

A multiple access scheme component may specify multiple access technique options, including technologies defining how communicating devices share a common physical channel, such as: code division multiple access (CDMA), space division multiple access (SDMA), time division multiple access (TDMA), frequency division multiple access (FDMA), orthogonal FDMA (OFDMA), single-carrier FDMA (SC-FDMA) which is also known as discrete Fourier transform spread OFDMA (DFT-s-OFDMA), low density signature multicarrier CDMA (LDS-MC-CDMA); non-orthogonal multiple access (NOMA); pattern division multiple access (PDMA); lattice partition multiple access (LPMA); resource spread multiple access (RSMA); and sparse code multiple access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources; and cognitive radio-based access. The air interfaces 190a and 190b may utilize other higher dimension signal spaces, which may involve a combination of orthogonal and/or non-orthogonal dimensions.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes and polar codes. Modulation may refer, simply, to the constellation (including, for example, the modulation technique and order), or more specifically to various types of advanced modulation methods such as hierarchical modulation and low PAPR modulation.

The air interfaces 190a and 190b may use similar communication technology, such as any suitable radio access technology.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs no and one or multiple NT-TRPs 172 for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the Internet 150, and the other networks 160).

In addition, some or all of the EDs 110a 110b, and 110c may include functionality for communicating with different wireless networks over different wireless links using different wireless technologies and/or protocols. Instead of wireless communication (or in addition thereto), the EDs 110a nob, and 110c may communicate via wired communication channels to a service provider or switch (not shown), and to the Internet 150. PSTN 140 may include circuit switched telephone networks for providing plain old telephone service (POTS). Internet 150 may include a network of computers and subnets (intranets) or both, and incorporate protocols, such as internet protocol (IP), transmission control protocol (TCP), user datagram protocol (UDP). EDs 110a 110b, and 110c may be multimode devices capable of operation according to multiple radio access technologies, and incorporate multiple transceivers necessary to support such.

In addition, the communication system 100 may comprising a sensing agent (not shown in the figure) to manage the sensed data from ED110 and or the T-TRP 170 and/or NT-TRP 172. In one implementation, the sensing agent is located in the T-TRP 170 and/or NT-TRP 172. In another implementation, the sensing agent is a separate node which has interface to communicate with the core network 130 and/or the RAN 120 (e.g., the T-TRP 170 and/or NT-TRP 172).

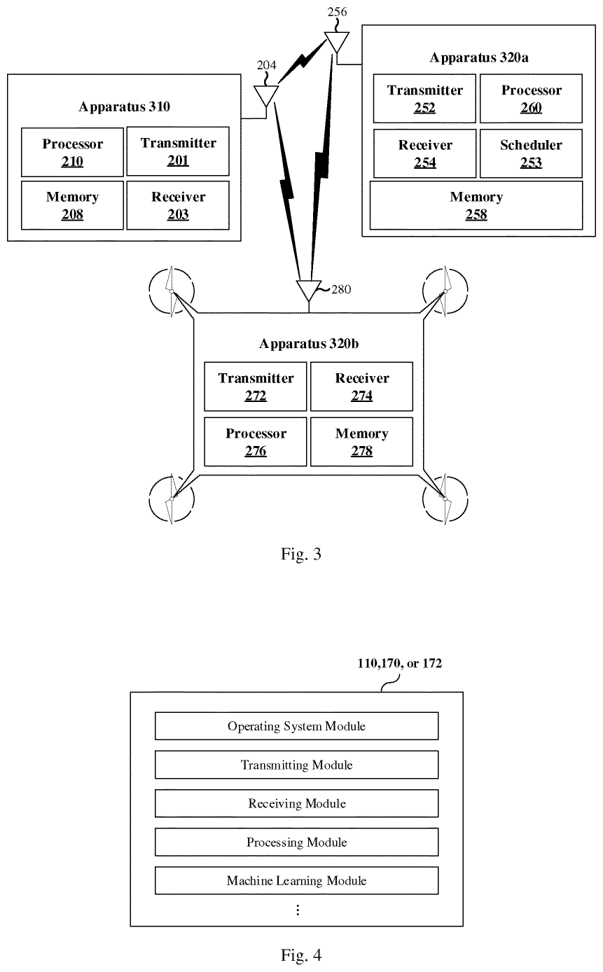

FIG. 3 illustrates example of an Apparatus 310 wirelessly communicating with at least one of two apparatuses (e.g., Apparatus 320a and Apparatus 320b, referred as Apparatus 310) in a communication system, e.g., the communication system 100, according to one embodiment. The Apparatus 310 may be a UE (e.g., ED 110 in FIG. 3). The Apparatus 320a may be a terrestrial network device (e.g., T-TRP 170 as shown in FIG. 3), and Apparatus 320b may be a non-terrestrial network device (e.g., NT-TRP 172 as shown in FIG. 3). However, this is not necessary. For example, Apparatus 320a may be a NT-TRP, and 320b may be a T-TRP, both Apparatus 320a and 320b may be T-TRPs or NT-TRPs, according to present disclosure.

In the following, the ED 110 as an example of the Apparatus 310 is described, and T-TRP 170 as an example of Apparatus 320a is described, and NT-TRP 172 as an example of Apparatus 320b is described. Although only one Apparatus 310, one Apparatus 320a and one Apparatus 320b are described, please note that the number of Apparatus 310 (e.g. ED 110) could be one or more, and the number of Apparatus 320a and/or 320b could be one or more. For example, one ED110 may be served by only one T-TRP 170 (or one NT-TRP 172), by more than one T-TRP 170, by more than one NT-TRP 172, or by one or more T-TRP 170 and one or more NT-TRP 172.

The ED 110 is used to connect persons, objects, machines, etc. The ED 110 may be widely used in various scenarios including, for example, cellular communications, device-to-device (D2D), vehicle to everything (V2X), peer-to-peer (P2P), machine-to-machine (M2M), MTC, internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to but not limited to) as a user equipment/device (UE), a wireless transmit/receive unit (WTRU), a mobile station, a fixed or mobile subscriber unit, a cellular telephone, a station (STA), a MTC device, a personal digital assistant (PDA), a smartphone, a laptop, a computer, a tablet, a wireless sensor, a consumer electronics device, a smart book, a vehicle, a car, a truck, a bus, a train, or an IoT device, wearable devices (such as a watch, a pair of glasses, head mounted equipment, etc.), an industrial device, or an apparatus in (e.g. communication module, modern, or chip) or comprising the forgoing devices, among other possibilities. Future generation EDs 110 may be referred to using other terms. The base station 170a and 170b is a T-TRP and will hereafter be referred to as T-TRP 170. Also shown in FIG. 3, a non-terrestrial (NT) device will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

As shown in FIG. 3, the ED 110(Apparatus 310) include at least one processor 210. Only one processor 210 is illustrated to avoid congestion in the drawing. The ED 110 may further include a transmitter 201 and a receiver 203 coupled to one or more antennas 204. Only one antenna 204 is illustrated to avoid congestion in the drawing. One, some, or all of the antennas 204 may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals. The ED 110 may include at least one memory 208. Only the transmitter 201, receiver 203, processor 210, memory 208, and antenna 204 is illustrated for simplicity, but the ED 110 may include one or more other components.

The memory 208 stores instructions. The memory 208 may also stores data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the Internet 150 in FIG. 1). The input/output devices or interfaces permit interaction with a user or other devices in the network. Each input/output device or interface includes any suitable structure for providing information to or receiving information from a user, and/or for network interface communications. Suitable structures include, for example, a speaker, microphone, keypad, keyboard, display, touch screen, etc.

The processor 210 performs (or controlling the ED110 to perform) operations described herein as being performed by the ED110. As illustrated below and elsewhere in the present disclosure. For example, the processor 210 performs or controls the ED110 to perform receiving transport blocks (TBs), using a resource for decoding of one of the received TBs, releasing the resource for decoding of another of the received TBs, and/or receiving configuration information configuring a resource. In details, the operation may include those operations related to preparing a transmission for uplink transmission to the NT-TRP 172 and/or the T-TRP 170; those operations related to processing downlink transmissions received from the NT-TRP 172 and/or the T-TRP 170; and those operations related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Processing operations related to processing sidelink transmissions may include operations such as transmit/receive beamforming, modulating/demodulating and encoding/decoding symbols.

Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g. beam angle information (BAI), received from the T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201, and the processing components of the receiver 203 may each be implemented by the same or different one or more processors that are configured to execute instructions stored in a memory (e.g. in the memory 208). Alternatively, some or all of the processor 210, the processing components of the transmitter 201, and the processing components of the receiver 203 may each be implemented using dedicated circuitry, such as a programmed field-programmable gate array (FPGA), an application-specific integrated circuit (ASIC), or a hardware accelerator such as a graphics processing unit (GPU) or an artificial intelligence (AI) accelerator.

In some implementations, the ED 110 may be an apparatus (also called component), for example, communication module, modern, chip, or chipset, it includes at least one processor 210, and an interface or at least one pin. In this scenario, the transmitter 201 and receiver 203 may be replaced by the interface or at least one pin, wherein the interface or at least one pin is to connect the apparatus (e.g., chip) and other apparatus (e.g., chip, memory, or bus). Accordingly, the transmitting information to the NT-TRP 172 and/or the T-TRP 170 and/or another ED 110 may be referred as transmitting information to the interface or at least one pin, or as transmitting information to the NT-TRP 172 and/or the T-TRP 170 and/or another ED 110 via the interface or at least one pin, and receiving information from the NT-TRP 172 and/or the T-TRP 170 and/or another ED 110 may be referred as receiving information from the interface or at least one pin, or as receiving information from the NT-TRP 172 and/or the T-TRP 170 and/or another ED 110 via the interface or at least one pin. The information may include control signaling and/or data. For other nodes/entities in this disclosure, similar rule applies.

As shown in FIG. 3, the T-TRP 170 (Apparatus 320a) include at least one processor 260. Only one processor 260 is illustrated to avoid congestion in the drawing. The T-TRP 170 may further include at least one transmitter 252 and at least one receiver 254 coupled to one or more antennas 256. Only one antenna 256 is illustrated to avoid congestion in the drawing. One, some, or all of the antennas 256 may alternatively be panels. The transmitter 252 and the receiver 254 may be integrated as a transceiver. The T-TRP 170 may further include at least one memory 258. The T-TRP 170 may further include scheduler 253. Only the transmitter 252, receiver 254, processor 260, memory 258, antenna 256 and scheduler 253 are illustrated for simplicity, but the T-TRP may include one or more other components.

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a terrestrial node, a terrestrial network device, a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 170 may be a macro base station (BS), a pico BS, a relay node, a donor node, or the like, or combinations thereof. The T-TRP 170 may refer to the forgoing devices or refer to apparatus (e.g. a communication module, a modem, or a chip) in the forgoing devices.

In some embodiments, the parts of the T-TRP 170 may be distributed. For example, some of the modules of the T-TRP 170 may be located remote from the equipment that houses the antennas 256 for the T-TRP 170, and may be coupled to the equipment that houses the antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses the antennas 256 of the T-TRP 170. The modules may also be coupled to other T-TRPs. In some embodiments, the T-TRP 170 may actually be a plurality of T-TRPs that are operating together to serve the ED 110, e.g. through the use of coordinated multipoint transmissions.

The processor 260 performs operations including those related to: preparing a transmission for downlink transmission to the ED 110, processing an uplink transmission received from the ED 110, preparing a transmission for backhaul transmission to the T-TRP 170 and/or NT-TRP 172, and processing a transmission received over backhaul from the T-TRP 170 and/or NT-TRP 172. Processing operations related to preparing a transmission for downlink or backhaul transmission may include operations such as encoding, modulating, precoding (e.g. multiple input multiple output (MIMO) precoding), transmit beamforming, and generating symbols for transmission. Processing operations related to processing received transmissions in the uplink or over backhaul may include operations such as receive beamforming, demodulating received symbols, and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates an indication of beam direction, e.g. BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252.

The scheduler 253 may be coupled to the processor 260 or integrated in the processor 260. The scheduler 253 may be included within or operated separately from the T-TRP 170. The scheduler 253 may schedule uplink, downlink, sidelink, and/or backhaul transmissions, including issuing scheduling grants and/or configuring scheduling-free (e.g., “configured grant”) resources.

The memory 258 is configured to store information, and optionally data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252, and the processing components of the receiver 254 may each be implemented by the same or different one or more processors that are configured to execute instructions stored in a memory, e.g. in the memory 258. Alternatively, some or all of the processor 260, the scheduler 253, the processing components of the transmitter 252, and the processing components of the receiver 254 may be implemented using dedicated circuitry, such as a programmed FPGA, a hardware accelerator (e.g., a GPU or AI accelerator), or an ASIC.

When the T-TRP 170 is an apparatus (also called as component), for example, communication module, modem, chip, or chipset in a device, it includes at least one processor, and an interface or at least one pin. In this scenario, the transmitter 252 and receiver 254 may be replaced by the interface or at least one pin, wherein the interface or at least one pin is to connect the apparatus (e.g., chip) and other apparatus (e.g., chip, memory, or bus). Accordingly, the transmitting information to the NT-TRP 172 and/or the T-TRP 170 and/or ED 110 may be referred as transmitting information to the interface or at least one pin, and receiving information from the NT-TRP 172 and/or the T-TRP 170 and/or ED 110 may be referred as receiving information from the interface or at least one pin. The information may include control signaling and/or data.

Although the NT-TRP 172 is illustrated as a drone only as an example, the NT-TRP 172 may be implemented in any suitable non-terrestrial form, such as satellites and high altitude platforms, including international mobile telecommunication base stations and unmanned aerial vehicles, for example. Also, the NT-TRP 172 may be known by other names in some implementations, such as a non-terrestrial node, a non-terrestrial network device, or a non-terrestrial base station.

As shown in FIG. 3, the NT-TRP 172(Apparatus 320b) include at least one processor 276. Only one processor 276 is illustrated to avoid congestion in the drawing. The NT-TRP 172 may include a transmitter 272 and a receiver 274 coupled to one or more antennas 280. Only one antenna 280 is illustrated to avoid congestion in the drawing. One, some, or all of the antennas may alternatively be panels. The transmitter 272 and the receiver 274 may be integrated as a transceiver. The NT-TRP 172 may further include at least one memory 278. The NT-TRP 172 may further include scheduler. Only the transmitter 272, receiver 274, processor 276, memory 278, antenna 280 are illustrated for simplicity, but the NT-TRP may include one or more other components.

The NT-TRP 172 include a processor 276 for performing operations including those related to: preparing a transmission for downlink transmission to the ED 110, processing an uplink transmission received from the ED 110, preparing a transmission for backhaul transmission to T-TRP 170 and/or another NT-TRP 172, and processing a transmission received over backhaul from the T-TRP 170 and/or another NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating received symbols, and decoding received symbols. In some embodiments, the processor 276 implements the transmit beamforming and/or receive beamforming based on beam direction information (e.g. BAI) received from the T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The memory 278 is configured to store information and optionally data. The memory 278 stores instructions and data used, generated, or collected by the NT-TRP 172. For example, the memory 278 could store software instructions or modules configured to implement some or all of the functionality and/or embodiments described herein and that are executed by the processor 276.

Although not illustrated, the processor 276 may form part of the transmitter 272 and/or part of the receiver 274. Although not illustrated, the memory 278 may form part of the processor 276.

The processor 276, the processing components of the transmitter 272, and the processing components of the receiver 274 may each be implemented by the same or different one or more processors that are configured to execute instructions stored in a memory, e.g. in the memory 278. Alternatively, some or all of the processor 276, the processing components of the transmitter 272, and the processing components of the receiver 274 may be implemented using dedicated circuitry, such as a programmed FPGA, a hardware accelerator (e.g., a GPU or AI accelerator), or an ASIC. In some embodiments, the NT-TRP 172 may actually be a plurality of NT-TRPs that are operating together to serve the ED 110, e.g. through coordinated multipoint transmissions.

When the NT-TRP 172 is an apparatus (e.g. communication module, modem, chip, or chipset) in a device, it includes at least one processor, and an interface or at least one pin. In this scenario, the transmitter 272 and receiver 274 may be replaced by the interface or at least one pin, wherein the interface or at least one pin is to connect the apparatus (e.g., chip) and other apparatus (e.g., chip, memory, or bus). Accordingly, the transmitting information to the T-TRP 170 and/or another NT-TRP 172 and/or ED 110 may be referred as transmitting information to the interface or at least one pin, and receiving information from the T-TRP 170 and/or another NT-TRP 172 and/or ED 110 may be referred as receiving information from the interface or at least one pin. The information may include control signaling and/or data.

Note that “TRP”, as used herein, may refer to a T-TRP or a NT-TRP. A T-TRP may alternatively be called a terrestrial network TRP (“TN TRP”) and a NT-TRP may alternatively be called a non-terrestrial network TRP (“NTN TRP”). The T-TRP 170, the NT-TRP 172, and/or the ED 110 may include other components, but these have been omitted for the sake of clarity.

Note that “signaling”, as used herein, may alternatively be called control signaling, control message, control information, or message for simplicity. Signaling between a BS (e.g., the network node 170) and a terminal or sensing device (e.g., ED 110), or signaling between different terminal or sensing device (e.g., between ED 110i and ED110j) may be carried in physical layer signaling (also called as dynamic signaling), which is transmitted in a physical layer control channel. For downlink the physical layer signaling may be known as downlink control information (DCI) which is transmitted in a physical downlink control channel (PDCCH). For uplink, the physical layer signaling may be known as uplink control information (UCI) which is transmitted in a physical uplink control channel (PUCCH). For sidelink, signaling between different terminal or sensing device (e.g., between ED 110i and ED110j) may be known as sidelink control information (SCI) which is transmitted in a physical sidelink control channel (PSCCH). Signaling may be carried in a higher-layer (e.g., higher than physical layer) signaling, which is transmitted in a physical layer data channel, e.g. in a physical downlink shared channel (PDSCH) for downlink signaling, in a physical uplink shared channel (PUSCH) for uplink signaling, and in a physical sidelink shared channel (PSSCH) for sidelink signaling. Higher-layer signaling may also called static signaling, or semi-static signaling. Higher-layer signaling may be radio resource control (RRC) protocol signaling or media access control-control element (MAC-CE) signaling. Signaling may be included in a combination of physical layer signaling and higher layer signaling.

It should be noted that in present disclosure, “information”, when different from “message”, may be carried in one single message, or be carried in more than one separate message.

One or more steps of the methods provided in this disclosure herein may be performed by corresponding units or modules, according to FIG. 4. FIG. 4 illustrates units or modules in a device or apparatus, such as in the ED 110, in the T-TRP 170, or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be a circuit such as an integrated circuit. Examples of an integrated circuit includes a programmed FPGA, a GPU, or an ASIC. For instance, one or more of the units or modules may be logical such as a logical function performed by a circuit, by a portion of an integrated circuit, or by software instructions executed by a processor. It will be appreciated that where the modules are implemented using software for execution by a processor for example, the modules may be retrieved by a processor, in whole or part as needed, individually or together for processing, in single or multiple instances, and that the modules themselves may include instructions for further deployment and instantiation. For other nodes/entities in this disclosure, similar units or modules applies.

Additional details regarding the EDs 110, the T-TRP 170, and the NT-TRP 172 are known to those of skill in the art. As such, these details are omitted here.

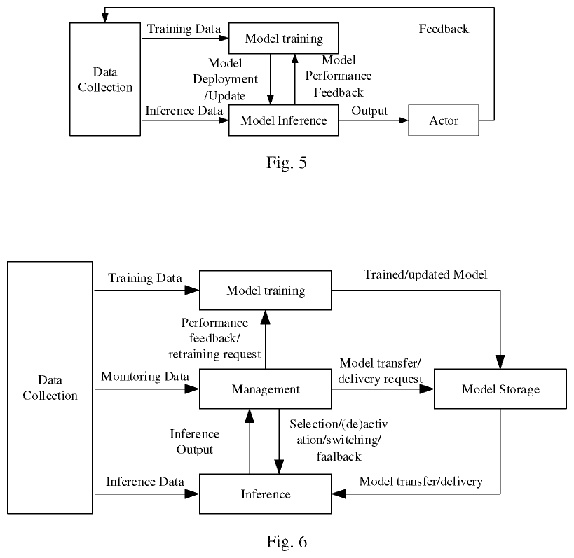

In 5G NR, the general AI/ML framework is discussed in both physical layer and higher layer. In TR 37.817, the basic functional framework for RAN intelligence is provided by 3GPP higher layer working group. AS shown in FIG. 5:

Data collection is a function that provides input data to model training and model inference functions.

Model training is a function that performs the AI/ML model training, validation, and testing which may generate model performance metrics as part of the model testing procedure.

Model inference is a function that provides AI/ML model inference output (e.g., predictions or decisions). Model inference function may provide model performance feedback to model training function when applicable.

Actor is a function that receives the output from the model inference function and triggers or performs corresponding actions. The Actor may trigger actions directed to other entities or to itself.

Feedback from actor is the information that may be needed to derive training data, inference data or to monitor the performance of the AI/ML Model, and its impact to the network through updating of KPIs and performance counters.

3GPP physical layer working group also discussed the general AI/ML framework for air interface. As shown in FIG. 6, the basic procedure is similar with the framework provided by higher layer working group.

Data collection can provide training data, monitoring data and inference data to model training, model management and model inference functions, separately.

The trained model or updated model is stored in model storage function. When the model transfer/delivery request is triggered by model management function, the model is delivered to Inference function

The inference output can be sent to model management function, the monitoring is performed by comparing the monitoring data with the inference output, and the controlling action such as selecting the other model, (de)activating the current model, switching from the currently active model to the other model is indicated to model inference function.

The monitoring results or the retraining request can also be sent to model training function. The re-training is triggered by the feedback from model management function.

Sensing is another hot topic in 6G research, the sensing data derived by sensor, radar, camera, Wi-Fi, bluetooth has been applied in multiple areas such agriculture, medicine, education, communication and entertainment. The AI/ML and sensing are important technologies for 6G or other communication systems integrating AI/ML and data sensing. The two technologies can be influenced or enhanced by each other. Therefore, the integration of the two technologies needs to be studied.

In general, one or more embodiments in the disclosure involve methods, apparatuses, systems for one or more of the following problems: what is the structure of the integrated framework for AI/ML and sensing, how AI/ML and sensing enhance each other, how to identify sensing service request, how to satisfy the sensing service QoS requirement during the sensing data collection and indication.

Based on the above issues, one or more embodiments in the disclosure is related to:

The sensing data generated by RAN has the following function in 6G or other communications systems: assist data communication, provide to 3rd sensing service, used for AI/ML model training/inference/monitoring, provide to local service.

The sensing request can be identified by the assonated resources or the explicit indication.

The sensing service QoS requirement is satisfied by the pre-configured air interface configuration.

In some implementations of the disclosure, one intelligent RAN framework which integrates AI/ML and sensing is provided. The sensing data generated by RAN can be used to assist communication. In addition, RAN can also provide sensing data to 3rd sensing service and AI/ML model training. For the AI/ML technology, it can be used to enhance different communication service and assist the sensing data collection.

For ease of understanding, an example of an intelligent RAN framework which integrates AI/ML and sensing is provided.

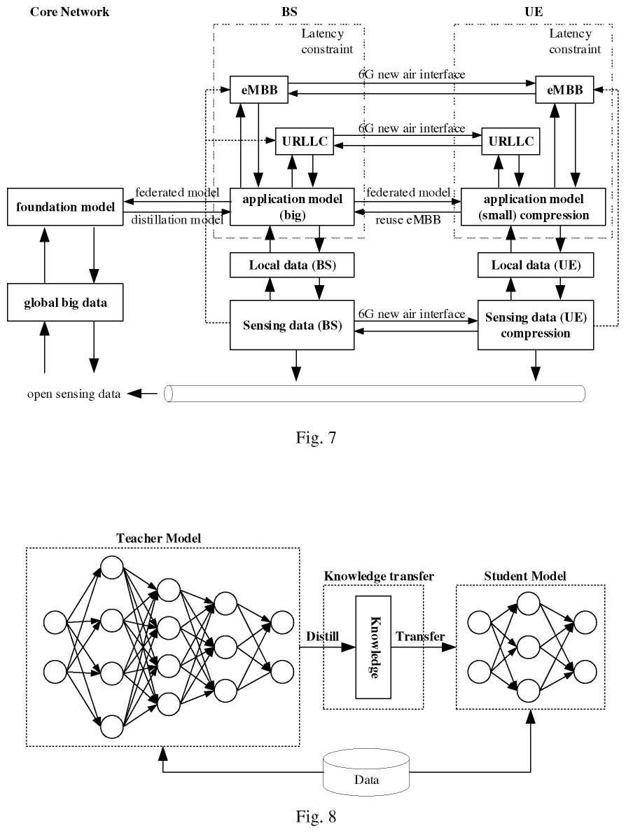

As shown in FIG. 7, where the AI/ML and sensing can be influenced and enhance by each other.

The intelligent RAN framework comprises a core network, one or more BSs (e.g. T-TRP 170, NT-TRP 172, etc.) and one or more UEs (e.g. ED 110, etc.). The one or more BSs can communicate to each other across the core network, and each BS carries at least one UE. One or more foundation models are deployed in the core network, while one or more big scale application models (hereafter refers to big application model or big model) are deployed in each BS and one or more small scale application models (hereafter refers to small application model or small model) are deployed in each UE. Wherein:

Foundation model: The foundation model is trained at core network by the global big data. Based on the foundation model, core network can generate multiple smaller distillation models by knowledge distillation to satisfy the various service requirements at different BS. FIG. 8 illustrates a knowledge distillation process.

Knowledge distillation refers to the process of transferring the knowledge from a large model or set of models to a single smaller model that can be practically deployed under real-world constraints.

In knowledge distillation, a small “student” model learns to mimic a large “teacher” model and leverage the knowledge of the teacher to obtain similar or higher accuracy.

### Big Application Model at BS

Core network transmits the distillation model generated from the foundation model to BS. The model which is trained based on the distillation model can be regarded as big application model at BS.

To take advantage of the various data sets at different BS, the big application model can be trained by federated leaning (FL).

In FL training procedure, a common AI model is shared between master node (core network) and multiple local nodes (BS).

FIG. 9 illustrates an example of a knowledge distillation process.

As shown in FIG. 9, a training round in the knowledge distillation process comprises the following steps:

Step 1: The master node may broadcast the common AI model (with the model parameters such as weights) to the local nodes;

Step 2: Each local trains the common model with local training data (or training dataset, training samples) over one or more iterations, where the training data in this learning scheme is of privacy that may be protected,

Step 3: Local nodes report the model parameter gradients (i.e., slopes of the model parameters) to the master node

Step 4: Master node uses these reports from the multiple local nodes for the global model training and updates the common AI model parameters at the master node.

Such training cycle repeats until the common AI model converges or master node determines to stop based on certain criteria.

Small application model at UE: Considering the different UE capability and QoS requirement, the big application model can be compressed to small application model. There are two ways to compress the big application model:

In some embodiments, BS broadcasts the big application model to multiple UEs with UE dedicated compression information, then each UE compresses the big application model to small application model by the instruction of the compression information.

In some embodiments, BS compresses the big application model to small application model for each UE, and transmits the compressed small model to each UE.

In some embodiments, the model can be delivered by enhanced mobile broadband (eMBB) related technology.

In some embodiments, the model can be delivered by URLLC related technology.

Similarly, the small application model at multiple UEs can be enhanced by federate learning with BS. The detailed procedure can refer to the federate learning for big application model in above section.

### Data Transmission Enhanced by the Big/Small Application Model

With the help of the big application model and small application model, the performance of data transmission can be improved further. The downlink eMBB or URLLC data transmission can be enhanced by big application model at BS. Some of algorithms or modules can be replaced by the AI model. Similarly, the uplink eMBB or URLLC data transmission can be enhanced by small application model at UE. The new air configuration can be introduced by applying the AI/ML model.

### Sensing Enhanced by the Big/Small Application Model

The sensing procedure can be enhanced by the big/small application model. For example, the optimal air interface configuration for sensing signal transmission and sensing data indication can be derived by AI/ML model.

### Sensing Function

### Sensing Data Collection

The sensing data can be collected by two way:

A first method for sensing data collection is a radio sensing based method: The sensing data is collected by transmitting and/or receiving the radio sensing signal. In some embodiments, new air configuration may be needed for the first method.

A second method for sensing data collection is a non-radio sensing based method: The sensing data is collected by the local sensor and camera, and sensing data collected by this way can be regarded as local data.

### Sensing Assist Communication

The sensing data collected by BS and UE can be used to assist the downlink and uplink data communication, e.g., eMBB or URLLC. Some procedure or algorithm can be simplified with the help of sensing data. For example, with the environment map, the procedure of channel estimation can be simplified largely, and the overhead of reference signal measurement and report can be reduced accordingly.

### Open Sensing Data to 3rd Party

The sensing collection by RAN can also be provided to 3rd party. The sensing service request from 3rd party can include environmental reconstruction, detection, localization, and tracking, and the sensing data can be applied to multiple areas such as industry, agriculture, medicine and entertainment.

### The Sensing Data is Used in AI/ML Function

The sensing data can be taken as input for AI training, inference and monitoring. For AI training, the input and/or output data can be collected by sensing. For AI inference, the input data can be sensing data. While for AI model monitoring, the ground truth can be sensing data.

### The Sensing Data is Used for Services

In some embodiments, the sensing data may be used for any local service(s) in a communication system or 3rd part service(s). For example, the services may comprise one or more of the following services:

### Artificial Intelligence Service Provides AI Capability to Support a Variety of AI Applications.

Service of data collection, data sanitization, data analysis and data delivery are denoted as data analytics and management (DAM) as a service, this service provides a capability of lifecycle management of statistic data, including acquisition, de-privatization, analysis and delivery of data which are information statistic data from any types of sensors, devices, network functions, and etc.

Service of storage and sharing of data, this service provides a capability to trustworthily storage and share data under the control of owners of data and following recognized authorities' regulations on control of identified data.

Service to provide digital world, digital world service provides a capability to construct, control and manage digital world. Digital world is defined as digital realization of physical world.

Enhanced connectivity service, e.g. network for connectivity. This service provides a capability to support exchange of messages and data among services.

Services for control and management plane, e.g. service for resource management, mission management, service provisioning management, connectivity management, connect, protocol, network security management, etc.

Services for infrastructure, e.g. service for RAN infrastructure, core network infrastructure, satellite infrastructure, data center infrastructure (cloud), database (storage) infrastructure, etc.

The whole picture of intelligent RAN framework is provided in the embodiments shown in FIG. 7 to FIG. 9, and the relationship and possible signaling exchange between AI and sensing is introduced. The AI and sensing can enhance each other by the intelligent framework.

To realize the data sensing procedure, when sensing data for one or more services (e.g. communication service, AI/ML service, etc.) is needed, a first network element (e.g. UE, BS, network element with 3rd service deployed, etc.) may transmit a sensing request and information indicating sensing QoS (e.g. positioning accuracy, speed accuracy, angle accuracy, positioning resolution, speed resolution, angle resolution, sensing range, latency, identification probability, false alarm probability and missed detection probability, etc.) for sensing the sensing data to one or more second network elements (e.g. UE, BS, etc.). The one or more second network elements may collect the sensing data based on the received sensing QoS and transmit the sensing data to the first network element. The first network element may perform the one or more service while the sensing data is received.

In some embodiments, the first network element may be BS or UE in a communication system.

In some embodiments, the first network element may be a network element with one or more services deployed.

In some embodiments, the sensing request and the QoS may be transmitted to the one or more second network element implicit and/or explicit. The detail ways for transmitting the sensing request and the QoS may be described below.

In some embodiments, the one or more second network element may collect sensing data by their local sensors and/or transmit wireless signals. In the scenarios that the one or more second network element collect sensing data by transmit wireless signals, the configuration of the air interface may influence the quality of collected sensing data. Hence the one or more second network element may configure their air interface according to the QoS to guarantee the quality of data sensing. The detail ways for configuring air interface for data sensing may be described below.

### Sensing Request and QoS Identification

The following embodiments involve method for transmitting and identifying the sensing request and the corresponding QoS.

In some embodiments, the sensing request and the corresponding QoS is identified at physical layer, e.g., the sensing request and the QoS are transmitted by PUCCH or PDCCH. The sensing request and QoS can be transmitted by implicit ways or explicit ways, or one is transmitted by implicit ways and the other one is transmitted by explicit ways.

A first method for transmitting and identifying sensing request in implicit ways is described below.

In some embodiments, the sensing request is indicated by scheduling request (SR) resources, and sensing QoS is associated with SR resources. For example, when the sensing request is generated at UE, e.g. initiated from UE's application layer, the sensing request can be transferred to UE's physical layer, and transmitted to BS by the pre-configured SR resources. In order to distinguish the SR and sensing request, one new type filed can be added in the SR resource configuration.

In some embodiments, the sensing QoS can also be indicated by the associated SR resource, e.g., by adding one or more QoS related fields in SR resource configuration.

For example, SR resources may directly indicate one or more QoS performance metric. E.g. Each performance metric is indicated by one field. The performance metrics may include positioning accuracy, speed accuracy, angle accuracy, positioning resolution, speed resolution, angle resolution, sensing range, latency, identification probability, false alarm probability and missed detection probability.

For another example, SR resources may indicate the sensing QoS level. To reduce the indication overhead, one possible way is to map the multiple performance metrics to different level, and indicate QoS levels directly. The mapping between QoS level and the multiple performance metrics can be provided by the pre-configured table. Multiple tables can be configured to support different sensing service type. e.g., environmental reconstruction, detection, localization and tracking. Table. 1 and Table. 2 gives two illustrations.

TABLE 1
sensing QoS level for environmental reconstruction
Environmental reconstruction

| Sensing | | | | | |
|---|---|---|---|---|---|
| QoS | Positioning | Speed | Angle | Sensing | |
| Level | accuracy | accuracy | accuracy | range | latency |
| 0 | 20 m | 20 km/h | 15° | 100 m | 50 ms |
| 1 | 10 m | 10 km/h | 10° | 200 m | 20 ms |
| 2 | 5 m | 5 km/h | 8° | 400 m | 10 ms |
| 3 | 1 m | 2 km/h | 5° | 500 m | 5 ms |
| 4 | 0.5 m | 1 km/h | 3° | 800 m | 2 ms |
| 5 | 0.2 m | 0.5 km/h | 1° | 1000 m | 1 ms |

As shown in Table. 1, for an environmental reconstruction service, the sensing QoS may comprise 5 performance metrics (positioning accuracy, speed accuracy, angle accuracy, sensing range and latency). Six sensing QoS level are predefined (level 0, level 1, level 2, level 3, level 4 and level 5), in which each level indicating a group of values corresponding to the 5 performance metrics. For example, the first network element may embed “3” in the SR resource associated with the sensing QoS, hence the one or more second network element may identify a sensing QoS with 1 m of positioning accuracy, 2 km/h of speed accuracy, 5° of angle accuracy, 500 m of sensing range and 5 ms latency based on the “3” and Table. 1.

TABLE 2
sensing QoS level for detection, localization and tracking
Detection, localization and tracking

| | | | | | | | False | Missed |
|---|---|---|---|---|---|---|---|---|
| Sensing | Positioning | | Speed | | Angle | Identification | alarm | detection |
| QoS Level | accuracy | | accuracy | | Accuracy | Probability | probability | probability |
| 0 | 10 | m | 10 | km/h | 10° | 75% | 15% | 20% |
| 1 | 5 | m | 8 | km/h | 8° | 80% | 12% | 15% |
| 2 | 2 | m | 5 | km/h | 5° | 85% | 10% | 12% |
| 3 | 1 | m | 1 | km/h | 3° | 90% | 8% | 10% |
| 4 | 0.5 | m | 0.5 | km/h | 2° | 95% | 5% | 5% |
| 5 | 0.1 | m | 0.1 | km/h | 1° | 99% | 1% | 1% |

As shown in Table. 2, for a detection, localization or tracking service, the sensing QoS may comprise 6 performance metrics (positioning accuracy, speed accuracy, angle accuracy, identification probability, false alarm probability and missed detection probability). Six sensing QoS level are predefined (level 0, level 1, level 2, level 3, level 4 and level 5), in which each level indicating a group of values corresponding to the 6 performance metrics. For example, the first network element may embed “2” in the SR resource associated with the sensing QoS, hence the one or more second network element may identify a sensing QoS with 2 m of positioning accuracy, 5 km/h of speed accuracy, 5° of angle accuracy, 85% of identification probability, 10% of false alarm probability and 12% of missed detection probability based on the “2” and Table. 2.

The sensing QoS level or performance metric or value of performance metric in Table. 1 and Table.2 are just examples. In other embodiments, environmental reconstruction service, detection service, localization service or tracking service may have more or less metrics, have more or less sensing QoS levels, which are not limited herein.

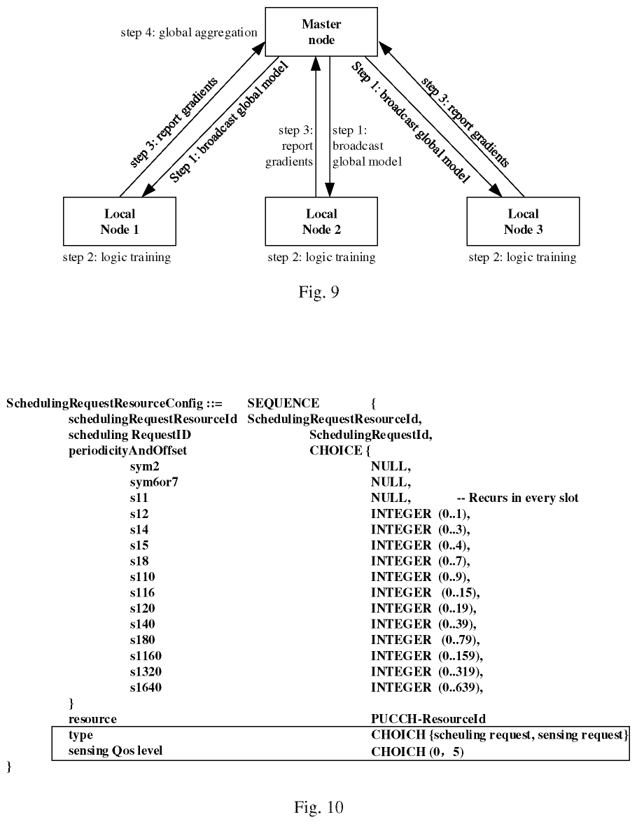

The illustration for sensing request and sensing QoS configuration is shown FIG. 10.

As shown in FIG. 10, the SR resource is added with two fields named “type” and “sensing QoS level”. The value range of field of “type” is “scheduling request” and “sensing request”, while value range of the field of “sensing QoS level” is from 0 to 5. With the configuration in FIG. 10, the one or more BS may identify a sensing request while the field of “type” in a SR is “sensing request”, and identify the sensing QoS level from the field of “sensing QoS level” in the SR.

The sensing request and sensing QoS identify by SR resource is shown in FIG. 11, where the two sensing requests with different sensing QoS levels are carried by two SR resources separately, BS can identify the sensing request and sensing QoS by the SR resources configuration. For example, with the SR resources 1 received, the BS may identify the sensing QoS level is 1, or with the SR resources 2 received, the BS may identify the sensing QoS level is 2.

In some embodiments, sensing request is indicated by dedicated sensing request resource, and the sensing QoS is associated with sensing request resources.

Configure dedicated PUCCH resource for sensing request, including the PUCCH format, periodicity, the starting slot/symbol index, the number of the occupied symbols, the starting RB index, the number of the occupied PRB.

The sensing QoS level can be indicated by the associated sensing request resource. The detailed indication method can refer to embodiments that transmitting the sensing request and sensing QoS level on SR resource, directly indicates the performance metrics or indicates the sensing QoS level.

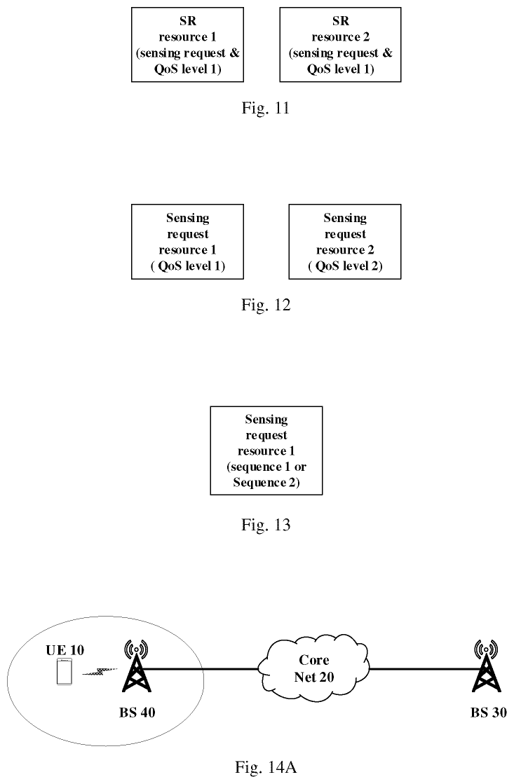

The sensing request and sensing QoS identify by sensing request resource is shown in FIG. 12, where the two sensing requests with different sensing QoS levels are carried by two sensing request resources separately, BS can identify the sensing request and sensing QoS by the sensing resources configuration. For example, with the sensing resources 1 received, the BS may identify the sensing QoS level is 1, or with the sensing resources 2 received, the BS may identify the sensing QoS level is 2.

In some embodiments, sensing request is identified by different sequence.

The sensing request is indicated by SR resource, and sensing request and SR is distinguished by different sequence or different parameter for one dedicated sequence. The different sensing QoS can also be indicated by different sequence or different parameter for one dedicated sequence. For example, the SR is indicated by low PAPR sequence, sensing request is indicated by Gold sequence, the different sensing QoS level is indicated by the initialization parameter for Gold sequence. Another example is both SR and sensing request are indicated by low PAPR sequence, and distinguished by different cyclic shifts.

The sensing request is indicated by dedicated sensing request resources, the different sensing QoS can also be indicated by different sequence or different parameter for one dedicated sequence, as shown in FIG. 13. For example, with a SR resource with sequence 1 (e.g., low PAPR sequence) received, the BS may identify that the SR resource indicating a SR. For another example, with a SR resource with sequence 2 (e.g., Gold sequence) received, the BS may identify that the SR resource indicating a sensing request and identify the sensing QoS level based on the initialization parameter of the Gold sequence.

A second method for transmitting and identifying sensing request with implicit and explicit ways is described below.

In scenarios that the sensing service initiated by UE, the sensing request is indicated by implication method provided in the aforementioned first method, while sensing QoS is explicitly indicated by in PUCCH, e.g., defining new uplink control information (UCI) for sensing QoS. The multiple QoS performance metrics can be defined separately or one general sensing QoS level is defined for multiple sensing QoS performance metrics. The mapping between multiple sensing QoS performance metrics and sensing QoS level can refer to the aforementioned first method.

In some embodiments, the UE may also transmit the sensing QoS via uplink data.

A third method for transmitting and identifying sensing request with: explicit way is described below.

In scenarios that the sensing service request is generated by 3rd party and sent to core network, the sensing request can be transferred to BS further. If the sensing data collection needs the UE to involve, the BS can explicitly indicate the sensing request and sensing QoS to UE by PDCCH.

In some embodiments, the sensing request and the corresponding sensing QoS is identified by core net, e.g., the sensing request and the QoS is transmitted by NAS layer.

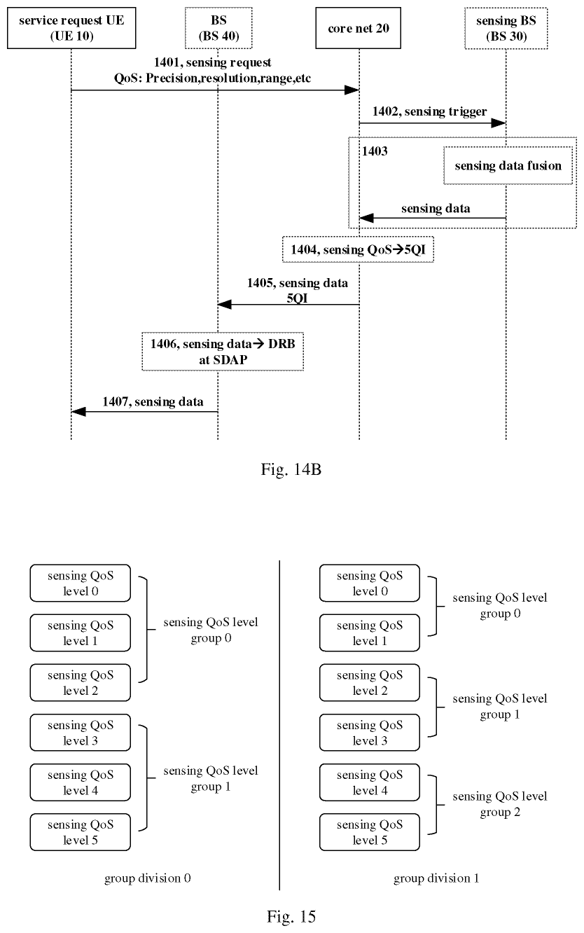

For example, as shown in FIG. 14A, the sensing request is generated by a 3rd sensing service configured at UE 10 (also refer to service request UE), UE 10 is served by BS 40 (which means BS 40 servers UE 10), sensing BS 30 and BS 40 are connected via core net 20 (also refers to core network 20). UE 10 may request one or more sensing BS 30 other than BS 40 to collect sensing data. The detailed steps are shown in FIG. 14B.

1401: UE 10 transmits the 3rd sensing service request and the associated sensing QoS to core net 20 by NAS lay, the sensing QoS can include precision (speed/location/angle), resolution (e.g. positioning resolution, speed resolution, angle resolution, etc.), range, latency, reliability (e.g. identification probability, false alarm probability and missed detection probability, etc.).

1402: core net 20 identifies the sensing request and triggers the sensing BS 30 to provide the sensing service.

With identification of sensing request and sensing QoS, core net 20 may trigger sensing BS 30 to provide sensing service. For example, the core net 20 may transmit sensing request and sensing QoS to sensing BS 30.

In some embodiments, the sensing BS 30 may not be the serving BS of the serving requesting UE.

1403: sensing BS 30 fuses sensing data and transmits sensing data to core net 20.

With receiving sensing request and sensing QoS, the sensing BS 30 may collect sensing data and fuse collected data. That is, the sensing data is fused at sensing BS 30 and transmitted to core net 20.

In some embodiments, sensing BS 30 may also trigger one or more UEs served by sensing BS 30 to collect sensing data. For example, sensing BS 30 may transmit sensing request and sensing QoS to the one or more UEs served by the BS 30. With the sensing request and sensing QoS, the one or more UEs may collect data and transmit collected data to sensing BS 30. Sensing BS 30 may fuse sensing data collected by itself and sensing data sent by the one or more UEs, and transmit fused sensing data to core net 20.

1404: Core net 20 transforms the sensing QoS to 5G QoS identifier (5QI).

The sensing data is associated to a 5QI (5G QoS Identifier) at core net 20 by the sensing QoS.

5QI is parameter indicating a group of values corresponding to QoS in 5G systems, e.g. 5QI may indicating values of resource type, packet error rate, packet delay budget, default maximum data burst volume default averaging window, etc. In other communication system, 5QI may have other names, which is not limited herein.

1405: Core net 20 transmits the sensing data and 5QI to BS 40.

The sensing data is transmitted to the BS (BS 40) which serves the sensing requesting UE (UE 10). In some embodiments, core net 20 may also transmit 5QI corresponding to the sensing data to BS 40.

1406: BS 40 map the sensing data to data radio bearer (DRB).

The sensing data is mapped to DRB at service data adaptation protocol (SDAP) layer at the BS which serves the requesting UE.

In some embodiments, sensing data collected by different network element may be associated with different 5QI. The sensing data with the same 5QI is mapped to one DRB, which may reduce resources used for transmitting sensing data to UE 10.

In some embodiments, BS 40 may also transmit data other than sensing data to UE 10. In those embodiments, BS 40 may map sensing data together with the data other than sensing data, e.g. map data with the same 5QI in both sensing data and data other than sensing data to one DRB.

1407: BS 40 transmits the sensing data to UE 10.

The sensing data is transmitted to sensing requesting UE (UE 10).

The above embodiments ensure the sensing request and sensing QoS can be identified at various scenarios and requirements. With the sensing request and sensing QoS, network element may collect sensing data based on the sensing QoS.

In some embodiments, the sensing data can be collected by transmitting the wireless signal, and the transmission procedure and configuration can impact the sensing data quality. To satisfy the various sensing QoS requirement, the dedicated air configuration should be provided for different kinds of sensing data collection. Air interface configuration

The detail of air interface parameter configuration will be described below.

The air interface configuration for sensing measurement and sensing results reporting is associated with the sensing QoS. In some embodiments, the sensing QoS level of each type of sensing service can be divided in to one or more sensing QoS level groups, and each sensing QoS level group may be associated with one set of pre-configured air interface parameters. Hence a network element may configure its air interface parameters with air interface parameters corresponding to the sensing QoS level group corresponding to the received sensing QoS level, and collect sensing data based on configured air interface parameters.

In some embodiments, the air interface parameters may comprise one or more parameters of the following parameters:

Allowed SCS (subcarrier spacing): To support the higher positioning/speed/angle accuracy and track the variation of sensing data, the more sensing signals should be transmitted within the pre-defined time duration. So the larger SCS which associates to smaller time unit should be configured for higher sensing QoS level, e.g., 240 kHz or 480 kHz, while 60 kHz or 120 kHz is configured for low sensing QoS level.

Sensing periodicity: Similarly, the smaller transmission periodicity for sensing signal can ensure the dense sensing data measurement, thus the higher accuracy and detection probability can be achieved.

Sensing window length: For some large scale and time-varying sensing data collection, e.g., the environmental map in urban scenario, the long-time collection may be needed, thus the large sensing window length may be needed for higher accuracy.

BW for sensing: The larger frequency bandwidth enables the more sensing signal transmissions at one time unit, and it also provides frequency selective performance gains, the deep fading on parts of frequency resources can be avoided by larger bandwidth. Thus larger bandwidth is configured for higher sensing QoS level.

Carrier frequency: The more frequency resources can be obtained at higher central frequency, e.g. THz, thus the high carrier frequency is configured for higher sensing QoS level. In some embodiments, carrier frequency may be indicate by wavelength, for example, “cm” may indicate a carrier frequency of any frequency corresponding to centimeter wave, and “mm” may indicate a carrier frequency of any frequency corresponding to millimeter wave.

Sensing waveform: The higher sensing level may introduce the larger throughput, thus the OFDM waveform which can support large throughput may be configured for the high sensing level, while the waveform such as chirp and DFT-s-OFDM can be configured for the relatively low sensing level.

Sensing power: The coverage range of the sensing signal is impacted by the transmission power. The larger transmission power enables larger coverage range.

Sensing method: For the sensing data collection with large range, the sensing data collected by single sensing node is not enough, the fused sensing data by the cooperative sensing among multiple sensing nodes may be needed.

Antenna elements: The scale of antenna elements also impacts the sensing accuracy. The large scale antenna elements incurs higher sensing accuracy.

Reporting data format: The sensing data may need compression and quantization before reporting, the low compression ratio and high quantization precision can ensure the smaller loss on sensing data.

Reporting resource: The high accuracy sensing data usually leads to large payload size, thus the dynamic scheduled PUSCH resources would match the transmission requirements more precisely, while the smaller resources provided by PUCCH or the semi-configured grant free resources may not satisfy high sensing QoS.

For example, for each sensing service type, the sensing QoS can be measured be the sensing QoS levels illustrated in Table. 1 and Table. 2. To decrease the air configuration overhead, the sensing QoS level can be divided into multiple groups. The group division method can be pre-configured, and multiple group divisions from the largest grouping granularity (one group for all the sensing QoS level) to the smallest grouping granularity (each sensing QoS level is one group) can be supported. Two grouping illustrations are shown in FIG. 15.

As shown in FIG. 15, a group division 0 may divide the six QoS levels in to 2 sensing QoS level groups (sensing QoS level group 0 and sensing QoS level group 1). Wherein, sensing QoS level group 0 comprise sensing QoS level 0, sensing QoS level 1 and sensing QoS level 2, and sensing QoS level group 1 comprise sensing QoS level 3, sensing QoS level 4 and sensing QoS level 5.

As shown in FIG. 15, a group division 1 may divide the six QoS levels in to 3 sensing QoS level groups (sensing QoS level group 0, sensing QoS level group 1 and sensing QoS level group 2). Wherein, sensing QoS level group 0 comprise sensing QoS level 0 and sensing QoS level 1, sensing QoS level group 1 comprise sensing QoS level 2 and sensing QoS level 3, and sensing QoS level group 2 comprise sensing QoS level 4, and sensing QoS level 5.

The division pattern shown in FIG. 15 is just an example, in other embodiments, the sensing QoS level may be divided by other patterns, which is not limited herein.

In some embodiments, each group corresponds to one set of pre-configured air interface parameters. Table. 3 shows an example of air interface parameters corresponding to the group division 0 shown in FIG. 15.

TABLE 3
Dedicated air interface for different type of sensing QoS level group

| | | low sensing QoS level | high sensing QoS |
|---|---|---|---|
| | | (0-2) | level (3-5) |
| sensing | allowed SCS | {60 kHz, 120 kHz} | {240 kHz, 480 kHz} |
| measurement | sensing periodicity | {1 ms, 2 ms} | {0.25 ms, 0.5 ms} |
| | sensing window | {500 ms, 1 s} | {2 s, 4 s} |
| | length | | |
| | BW for sensing | {50 MHz, 100 MHz} | {200M, 400M} |
| | carrier frequency | {cm, mm} | {mm, THz} |
| | sensing waveform | {chirp, DFT-s- | {OFDM} |
| | | OFDM} | |
| | sensing Tx Power | {15 dBm, 16 dBm} | {20 dBm, 23 dBm} |
| | sensing methods | {single node sensing} | {cooperative sensing} |
| | antenna elements | {small, medium} | Large |
| sensing | reporting data | {high compression | {low compression |
| results | format | ratio} | ratio} |
| reporting | reporting resources | {PUCCH, PUSCH, | {PUSCH} |
| | | GF} | |

As shown in Table. 3, the air interface is provided for two sensing QoS level groups. The sensing QoS level 0-2 can be regarded as low sensing QoS level (sensing QoS level group 0), while QoS level 3-5 corresponds to the high sensing QoS level (sensing QoS level group 1). For each sensing QoS level group, the air configuration for sensing measurement and sensing results reporting are provided, and the allowed parameter values are different.

In some embodiments, network element may obtain a set of air interface parameters in Table. 3 once a sensing request and sensing QoS are received. Then the network element may configure its air interface based on the obtained air interface parameters, and collect sensing data with the configured air interface parameters. For example, if a network element received a sensing QoS level “o”, the network element may configure its air interface based on air interface parameters corresponding to “low sensing QoS level”, e.g. configuring its allowed SCS to 60 kHz or 120 kHz, configuring its sensing periodicity to 1 ms or 2 ms, configuring its sensing window length to 500 ms or is, configuring its BW for sensing to 50 MHz or 100 MHz, configuring its carrier frequency to cm or mm, configuring its Sensing waveform to chirp or DFT-s-OFDM, configuring its Sensing Tx Power to 15 dBm or 16 dBm, configuring its Sensing methods to single node sensing, configuring its antenna elements to small or medium, configuring its reporting data format to high compression ratio, configuring its reporting resources to PUCCH, PUSCH or GF.

In some embodiments, BS may indicates air interface parameter to UE dynamically.

For example, BS may indicates air interface parameters within one sensing QoS level group

For each air interface configuration, multiple values are provided within one dedicated sensing QoS level group. BS dynamically indicates one of the values within the associated sensing QoS level group. E.g., for sensing QoS level 5 in Table. 3, BS may indicate sensing allowed SCS of 240 kHz or 480 kHz to UE. That is the BS may adopt 240 kHz or 480 kHz to configure the air interface with UE.

For another example, the BS may indicate air interface parameters within all the sensing QoS level. Due to the mapping between multiple performance metrics and sensing QoS level, and the air interface parameters for a dedicated sensing QoS level is pre-configured, it is possible that these configurations may not match with some personalized sensing service. In this case, the air interface parameters are indicated within all the sensing QoS level.

For example, BS may select a set air interface parameters among all available value, and transmit selected air interface parameters to the UE. Illustratively, BS may select some interface parameters corresponding to the low sensing QoS level in Table. 3 and select other interface parameters corresponding to the high sensing QoS level in Table. 3.

For example, when bandwidth for sensing is limited, the BS may indicate a narrow BW such as 50 MHz (or other values) for sensing. To ensure low latency for sensing, a large SCS such as 240 kHz may be selected as allowed SCS. When the channel condition is good enough to support the transmission of sensing signal, lower sensing Tx power such as 15 dbm can be chosen. To satisfy the high sensing accuracy, cooperative sensing is needed.

In some embodiments, UE can request all sensing QoS levels air interface configuration by the associated SR resources or implicit indication on PUCCH. BS can indicate air interface configuration within all the sensing QoS level groups by PDCCH.

With the air interface parameter configuration in above embodiments, the transmission overhead of air interface parameters can be decreased largely by the dedicated pre-configuration and dynamic indication.

The embodiments of this disclosure further provides a communication method.

FIG. 16 illustrates a flow diagram of a communication method according to some embodiments of the disclosure. As shown in FIG. 16, the method comprising:

1601, a first network element transmits a sensing request and a first information to one or more second network elements. Wherein, the first information indicates sensing QoS corresponding to the sensing request.

In some embodiments, sensing request may be generated by its local service(s) or 3rd service(s) based on their operating logic. For example, in case the first network element is a UE and the second element is a BS, and the UE may transmit sensing request to BS while there are data to be transmitted and the sensing request indicates the BS to collect data for channel estimation, construction or reconstruction.

In some embodiments, the first information may comprise detail values of performance metric(s) of sensing QoS. For example, a row of data in Table. 1 or Table. 2.

In some embodiments, the first information may comprise QoS level, which may reduce air interface resource compared with transmitting detail values of performance metric(s) of sensing QoS. For example, aforementioned sensing QoS level 0, 1, 2, 3, 4, or 5.

In some embodiments, the performance metrics comprising at least one of the following performance metrics: positioning accuracy, speed accuracy, angle accuracy, positioning resolution, speed resolution, angle resolution, sensing range, latency, identification probability, false alarm probability or missed detection probability.

In some embodiments, the sensing request and/or the sensing QoS may be transmitted in implicit ways and/or explicit ways. For example, transmit the sensing request and the first information on SR resource, or transmit the sensing request and the first information on PUCCH resources other than SR resource, or transmit the sensing request on SR resource and transmit the first information on PUCCH resources other than SR resource, or transmit the sensing request and the first information via PDCCH, transmit the sensing request and the first information via NAS layer. The detail ways for transmitting sensing request and sensing QoS may refer to embodiments shown in FIG. 10 to FIG. 14 and descriptions corresponding to those figures.

In some embodiments, the sensing request may request the one or more second network element to collect sensing data for a first service (local service on the first network element or 3rd service).

In some embodiments, the first network element may be a UE or a BS or other network element.

In some embodiments, the second network element may be a UE or a BS. In some embodiments, the sensing request and the first information may be transmitted to the second network element directly or in directly. For example, considering the first network element is a UE and the second network element is a BS serving the UE, the UE may transmit the sensing request and the first information to the BS directly, e.g. transmit the sensing request and the first information on SR resource, transmitting them via DCI or uplink data. For another example, considering the second network element is not the BS serving the UE, the UE may transmit the sensing request and the first information to the BS indirectly, e.g. via a core network combining the second network element and the BS serving the first network element (e.g. the procedure shown in FIG. 14).

1602, the one or more second network elements collect a sensing data based on the first information in response of the sensing request.

The one or more second network elements collect a sensing data by their selves and/or by one or more third network elements based on the first information in response of the sensing request. For example, considering the second network element is BS, the BS may collect the sensing data itself and/or instruct UE(s) served by the BS to collect the sensing data.

In some embodiments, the one or more second network elements may configure their air interface parameters according to the QoS and collect sensing data based on the sensing QoS in the first information and configured air interface parameters. The detail for configure air interface parameters may refer to the description in the aforementioned air interface parameter configuration parts.

In some embodiments, if one or more network elements (UE and/or BS) served by a second network element involve the sensing data procedure, the second network element may transmit the set of air interface parameters corresponding to the sensing QoS to the one or more network elements.

In some embodiments, sensing QoS may be divided into plenty of sensing QoS level groups, and each sensing QoS level group is corresponding to one or more sets of values of the air interface parameters. The one or more second network elements may determine the sensing QoS level group corresponding to the received first information, and select a set of air interface parameters from one or more sets of values of the air interface parameters corresponding to determined sensing QoS level group. In some embodiments, the one or more second network elements may select a set of air interface parameters from available values of multiple sensing QoS level groups case the values of the air interface parameters corresponding to determined sensing QoS level group cannot satisfy the demand of network element served by the second network element.

1603, the one or more second network elements transmit the sensing data to the first network element.

The one or more second network elements may transmit collected sensing data to the first network element.

In some embodiments, the one or more second network elements transmit the sensing data to the first network element directly (e.g. via PDSCH, PUSCH, etc.) or indirectly (e.g. forward by one or more network elements (UE, BS, core network, etc.).

1604, the first network element realizes related service(s) based on the sensing data.

The first network elements may realizes related service(s) based on the sensing data.

For example, consider that the first network is BS in FIG. 7, the BS may adopt the sensing data to train the big scale application model, input the a sensing data to the big scale application model to get a inferring result and adopt the inferring result to assist to eMBB and URLLC, or transmit the sensing data to the core net or UE, or transmit the sensing data to eMBB or URLLC or other service in the BS.

For another example, consider that the first network is UE in FIG. 7, the UE may adopt the sensing data to train the small scale application model, input the a sensing data to the small scale application model to get a inferring result and adopt the inferring result to assist to eMBB and URLLC, or transmit the sensing data to the BS or core network, or transmit the sensing data to or eMBB or URLLC or other service in the UE.

With the method in the above embodiments, network elements in communication system may collect sensing data for local service or 3rd service, and transmit collected sensing data to other network element in (or out of) the communication system.

An embodiment of this application further provides a computer-readable storage medium. The computer-readable storage medium stores computer instructions used to implement the method performed by the transmitting apparatus or the method performed by the receiving apparatus in the foregoing method embodiments.

For example, when the computer program is executed by a computer, the computer is enabled to implement the method performed by the transmitting apparatus or the method performed by the receiving apparatus in the foregoing method embodiments.

An embodiment of this application further provides a computer program product including instructions. When the instructions are executed by a computer, the computer is enabled to implement the method performed by the transmitting apparatus or the method performed by the receiving apparatus in the foregoing method embodiments.

An embodiment of this application further provides a communication system. The communication system includes the transmitting apparatus and the receiving apparatus in the foregoing embodiments.

For explanations and beneficial effects of related content of any communication apparatus provided above, refer to a corresponding method embodiment provided above. Details are not described herein again.

In some embodiments, at least parts of functions of UE or BS may be embedded into one or more chips or chipsets. The disclosure provides one or more chips or chipsets realizing at least parts of functions of UE or BS executing instructions or corresponding circuits.

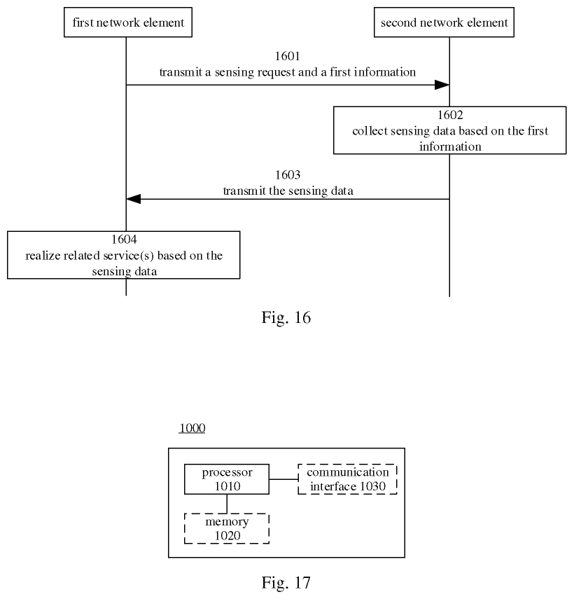

Illustratively, referring to FIG. 17, FIG. 17 shows a schematic block diagram of an apparatus according to some embodiments of this disclosure. The apparatus 1000 includes a processor 1010. The processor 1010 may be coupled to a memory 1020. The memory 1020 is configured to store a computer program or instructions and/or data. The processor 1010 is configured to execute the computer program or instructions and/or data stored in the memory 1020, so that the methods in the foregoing method embodiments are executed.

In some embodiments, the apparatus 1000 includes one or more processors 1010.

In some embodiments, as shown in FIG. 17, the apparatus 1000 may further include the memory 1020.

In some embodiments, the apparatus 1000 may include one or more memories 1020.

In some embodiments, the memory 1020 may be integrated with the processor 1010, or disposed separately from the processor 1010.

In some embodiments, as shown in FIG. 17, the apparatus 1000 may further include a communication interface 1030, and the communication interface 1030 is configured to communication with other apparatus/chips/device/chipset. For example, the processor 1010 is configured to receive a signal across a receiver or transmit a signal across a transmitter based on the communication interface 1030. For another example, the processor 1010 may store data to a memory or read data from a memory based on the communication interface 1030.

In some embodiments, the detail description of processor 1010 may refer to the aforementioned processor 210/260/276.

In some embodiments, the detail description of memory 1020 may refer to the aforementioned memory 208/258/278.

In some embodiments, the apparatus 1000 may comprise more modules.

In some embodiments, the apparatus 1000 may be applied as a BS or UE or network element in core net. And the apparatus 1000 may execute instructions to realize the steps executed by UE, BS, or core network in the aforementioned embodiments.

The processor mentioned in embodiments of this application may be a central processing unit (central processing unit, CPU), the processor may further be another general-purpose processor, a digital signal processor (digital signal processor, DSP), an ASIC, a FPGA, or another programmable logic device, a discrete gate, a transistor logic device, a discrete hardware component, or the like. The general-purpose processor may be a microprocessor, or the processor may be any conventional processor or the like.

The memory mentioned in embodiments of this application may be a volatile memory or a non-volatile memory, or may include a volatile memory and a non-volatile memory. The non-volatile memory may be a ROM, a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (RAM). For example, the RAM may be used as an external cache. By way of example but not limitation, the RAM may include a plurality of forms in the following: a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus random access memory (direct rambus RAM, DR RAM).

It should be noted that when the processor is a general-purpose processor, a DSP, an ASIC, an FPGA, another programmable logic device, a discrete gate or a transistor logic device, or a discrete hardware component, the memory (storage module) may be integrated into the processor.

It should be further noted that the memory described in this specification is intended to include, but is not limited to, these memories and any other memory of a suitable type.

A person of ordinary skill in the art may be aware that, in combination with the examples described in embodiments disclosed in this specification, units and methods may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the protection scope of this application.

It may be clearly understood by a person skilled in the art that, for the purpose of convenient and brief description, for a detailed working process of the foregoing apparatus and unit, refer to a corresponding process in the foregoing method embodiment. Details are not described herein again.

In the several embodiments provided in this application, the disclosed apparatuses and methods may be implemented in other manners. For example, the described apparatus embodiment is merely an example. For example, division into the units is merely logical function division and may be other division in an actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic forms, mechanical forms, or other forms.

The units described as separate parts may or may not be physically separate, and parts displayed as units may or may not be physical units, may be located in one position, or may be distributed on a plurality of network units. Some or all of the units may be selected based on an actual requirement to implement the solutions provided in this application.

In some embodiments, “and/or” forms a list of elements inclusive alone or in any combination. For example, an example described as including A, B, and/or C may indicating at least one of A, B, C, such as: A or B or C alone; A and B; A and C; B and C; A, B and C.

In some embodiments, “/” indicating a relationship of “or”. For example, an example described as A/B which may indicating A or B.

In addition, function units in embodiments of this application may be integrated into one unit, or each of the units may exist alone physically, or two or more units are integrated into one unit. All or some of foregoing embodiments may be implemented by using software, hardware, firmware, or any combination thereof. When the software is used to implement embodiments, all or a part of embodiments may be implemented in a form of a computer program product. The computer program product includes one or more computer instructions. When the computer program instructions are loaded and executed on the computer, the procedures or functions according to embodiments of this application are all or partially generated. The computer may be a general-purpose computer, a special-purpose computer, a computer network, or another programmable apparatus. For example, the computer may be a personal computer, a server, a network device, or the like. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, and microwave, or the like) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a DVD), a semiconductor medium (for example, a solid state disk (solid state disk, SSD)), or the like. For example, the usable medium may include but is not limited to any medium that can store program code, such as a USB flash drive, a removable hard disk, a ROM, a RAM, a magnetic disk, or an optical disc.

The foregoing description is merely a specific implementation of this application, but is not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims and the specification.

The various options and embodiments described herein may be combined in different permutations. Also, although the application has been described with reference to specific features and embodiments thereof, various modifications and combinations can be made thereto without departing from the application. The description and drawings above are, accordingly, to be regarded simply as an illustration of some embodiments of the application, and are contemplated to cover any and all modifications, variations, combinations or equivalents.

DEFINITIONS OF ACRONYMS & GLOSSARIES

| Acronym | Full Name |
|---|---|
| LTE | long term evolution |
| NR | new radio |
| BWP | bandwidth part |
| BS | base station |
| CA | carrier aggregation |
| CC | component carrier |
| CG | cell group |
| CSI | channel state information |
| CSI-RS | channel state information reference Signal |
| DC | dual connectivity |
| DCI | downlink control information |
| DL | downlink |
| DL-SCH | downlink shared channel |
| EN-DC | E-UTRA NR dual connectivity |
| | with MCG using E-UTRA and |
| | SCG using NR |
| gNB | next generation (or 5G) base station |
| HARQ-ACK | Hybrid automatic repeat request acknowledgement |
| MCG | master cell group |
| MCS | modulation and coding scheme |
| MAC-CE | medium access control-control Element |
| PBCH | physical broadcast channel |
| PCell | primary cell |
| PDCCH | physical downlink control channel |
| PDSCH | physical downlink shared channel |
| PRACH | physical random access channel |
| PRG | physical resource block group |
| PSCell | primary SCG Cell |
| PSS | primary synchronization signal |
| PUCCH | physical uplink control channel |
| PUSCH | physical uplink shared channel |
| RAN | radio access network |
| RACH | random access channel |
| RAPID | random access preamble identity |
| RB | resource block |
| RE | resource element |
| RRM | radio resource management |
| RMSI | remaining system information |
| RS | reference signal |
| RSRP | reference signal received power |
| RRC | radio resource control |
| SCG | secondary cell group |
| SFN | system frame number |
| SL | sidelink |
| SCell | secondary cell |
| SPS | semi-persistent scheduling |
| SR | scheduling request |
| SRI | SRS resource indicator |
| SRS | sounding reference signal |
| SSS | secondary synchronization signal |
| SSB | synchronization Signal Block |
| SUL | supplement uplink |
| QoS | quality of Service |
| TA | timing advance |
| TAG | timing advance group |
| TUE | target UE |
| UCI | uplink control information |
| UE | user equipment |
| UL | uplink |

What is claimed is:

1. A method at a first network element, the method comprising:
transmitting a sensing request and first information, wherein the sensing request is a request for one or more second network elements to collect sensing data, and the first information indicates a sensing quality of service (QoS) for collecting the sensing data; and
receiving the sensing data.

2. The method of claim 1, wherein:
the sensing QoS comprises one or more performance metrics including one or more of: positioning accuracy, speed accuracy, angle accuracy, positioning resolution, speed resolution, angle resolution, sensing range, latency, identification probability, false alarm probability, or missed detection probability.

3. The method of claim 2, wherein:
the first information comprises a first parameter indicating a set of values corresponding to the one or more performance metrics; or
the first information comprises a set of values corresponding to the one or more performance metrics.

4. The method of claim 1, wherein:
the sensing request and the first information are transmitted on a scheduling request (SR) resource; or
the sensing request and the first information are transmitted on physical uplink control channel (PUCCH) resources other than the SR resource; or
the sensing request is transmitted on the SR resource and the first information is transmitted on PUCCH resources other than the SR resource.

5. The method of claim 1, wherein the first network element is a base station (BS), the one or more second network elements comprise a user equipment (UE), and transmitting the sensing request and the first information comprises:
transmitting the sensing request and the first information to the UE via a physical downlink control channel.

6. The method of claim 1, wherein the first network element is a user equipment (UE) served by a first base station (BS), the one or more second network elements comprise a second BS, and transmitting the sensing request and the first information comprises:
transmitting the sensing request and the first information to the second BS via a core network.

7. The method according to claim 6, wherein receiving the sensing data comprises:
receiving the sensing data from the first BS, wherein the sensing data is obtained by the first BS via the second BS and the core network.

8. The method of claim 1, wherein the first network element is a user equipment (UE), the sensing data is an input or a training data of a first model deployed at the UE, and the first model is a compressed model of a second model deployed at a base station (BS) serving the UE.

9. The method of claim 1, wherein the first network element is a base station (BS), the sensing data is an input or a training data of a first model deployed at the BS, and the first model is a distilled model of a second model deployed at a core network.

10. A method at a second network element, the method comprising:
receiving a sensing request and first information, wherein the first information indicates a sensing quality of service (QoS) for collecting sensing data corresponding to the sensing request; and
transmitting the sensing data, wherein the sensing data is collected based on the sensing QoS.

11. The method of claim 10, wherein:
the sensing QoS comprises one or more performance metrics including one or more of: positioning accuracy, speed accuracy, angle accuracy, positioning resolution, speed resolution, angle resolution, sensing range, latency, identification probability, false alarm probability, or missed detection probability.

12. The method of claim 11, wherein:
the first information comprises a first parameter indicating a set of values corresponding to the one or more performance metrics; or
the first information comprises a set of values corresponding to the one or more performance metrics.

13. The method of claim 10, wherein the sensing data is collected by transmitting one or more signals, and the one or more signals is transmitted under a set of air interface parameters corresponding to the sensing QoS.

14. The method of claim 13, wherein the set of air interface parameters comprises one or more of:
allowed subcarrier spacing, sensing periodicity, sensing window length, bandwidth for sensing, carrier frequency, sensing waveform, sensing power, antenna elements, reporting data format, or reporting resource.

15. The method of claim 13, wherein the set of air interface parameters is selected from a plurality of sets of air interface parameters based on the first information.

16. The method of claim 13, wherein the second network element is a base station (BS), and the method further comprises transmitting the set of air interface parameters to one or more user equipments (UEs) served by the BS.

17. The method of claim 10, wherein the second network element is a base station, and:
the sensing request and the first information are received on a scheduling request (SR) resource, or the sensing request and the first information are received on physical uplink control channel (PUCCH) resources other than the SR resource, or the sensing request is received on the SR resource and the first information is received on PUCCH resources other than SR resource, or the sensing request and the first information are received from a core network.

18. The method of claim 10, further comprising:
collecting the sensing data based on a set of air interface parameters corresponding to the sensing QoS.

19. A method at core network element, the method comprising:
receiving a sensing request and first information, wherein the sensing request is a request for one or more second network elements to collect sensing data, and the first information indicates a sensing quality of service (QoS) for collecting the sensing data;
transmitting a trigger request to trigger the one or more second network elements to collect the sensing data based on the sensing QoS;
receiving the sensing data from the one or more second network elements; and
transmitting the sensing data.

20. The method according to claim 19, further comprising:
transmitting a second information indicating a legacy QoS identifier corresponding to the sensing QoS.
